(19) United States
(12) Patent Application Publication
(10) Pub. No.: US 2009/0030745 A1
(43) Pub. Date: Jan. 29, 2009

(54) SYSTEM FOR PROVIDING PLANS TO EATING AND DRINKING ESTABLISMENTS

(76) Inventor: Isao Ikezawa, Tokyo (JP)

Correspondence Address: JORDAN AND HAMBURG LLP, 122 EAST 42ND STREET, SUITE 4000, NEW YORK, NY, 10168, US

(21) Appl. No.: 11/921,284

(22) PCT Filed: May 29, 2006
(86) PCT No.: PCT/JP2006/310681

§ 371 Date: Jan. 8, 2008

(30) Foreign Application Priority Data
May 31, 2005 (JP) 2005-158375

(51) Int. Cl. G06Q 10/00

(52) U.S. Cl. 705/5; 705/1

(57) ABSTRACT

A system for providing plans to eating and drinking establishments, having eating and drinking establishment information storage unit; reservation information storage unit; plan acceptance device for receiving information relating to plans set by the eating and drinking establishments from terminals of the eating and drinking establishments. The system stores this information in the eating and drinking establishment information storage plan unit. A plan retrieval device for receiving search conditions for the plans from the user terminals is provided and configured for performing a search in the eating and drinking establishment information storage unit in order to determine whether or not there are plans that agree with the search conditions, and sending the search results to the user terminals. A reservation acceptance device for receiving information relating to reservations for a plan selected by the user from the user terminal is provided, and configured for registering the reservations by storing this information in the reservation information storage unit.

### TECHNICAL FIELD

The present invention relates to a system for providing plans to eating and drinking establishments with an object of improving the sales of eating and drinking establishments by providing plans for dates, times, and scenarios of quiet periods, busy periods, and the like, and accepting reservations for these periods, in order to improve the sales of these eating and drinking establishments.

### BACKGROUND ART

The sales volume of eating and drinking establishments depends in large part on the number of users, and the times at which eating and drinking establishments are used are usually similar for large numbers of users. For example, on weekdays, on Thursday and Friday, the time periods extending from 7:00 PM to around 9:00 PM are viewed as busy periods, and there may be sales with full reservations at eating and drinking establishments.

However, on weekdays and during time periods that are not busy periods, e.g., on weekdays such as Monday and Tuesday, and from around 5:00 PM to 7:00 PM, and after 9:00 PM, in terms of time periods, these are usually viewed as quiet periods, and how to get reservations for these periods is an important point for increasing sales.

Meanwhile, in busy periods, how to acquire reservations with a high unit cost is an important point for increasing the sales of an eating and drinking establishment.

Eating and drinking establishments have the ability to attract users by increasing their frame. Accordingly, systems for providing information about eating and drinking establishments in magazines, on the Internet, and the like have been disclosed in the following Patent Documents 1 through 5.

Patent Document 1: Japanese Laid-Open Patent Application No. 2002-73773

Patent Document 2: Japanese Laid-Open Patent Application No. 2002-279262

Patent Document 3: Japanese Laid-Open Patent Application No. 2003-76907

Patent Document 4: Japanese Laid-Open Patent Application No. 2003-122996

Patent Document 5: Japanese Laid-Open Patent Application No. 2004-326500

### DISCLOSURE OF THE INVENTION

### Problems to be Solved by the Invention

However, in these conventional systems, there is merely a provision of information such as menus, number of seats, and the like. Accordingly, in the case of such methods, even if it is possible to attract reservations during busy periods by increasing the degree of frame, it is not clear whether or not reserved guests who contribute to an increase in the sales of the eating and drinking establishment can be acquired. Specifically, it is not clear whether or not reserved guests can be acquired during quiet periods, and whether or not reserved guests with a high unit cost can be acquired during busy periods. For example, users visiting eating and drinking establishments are numerous on Thursday and Friday, and since most return to work, reservations during the abovementioned busy period can be increased; however, on Monday and Tuesday, and during the time period from around 5:00 PM to 7:00 PM and after 9:00 PM, when they are least likely to visit an eating and drinking establishment, the users do not have the ability even to make a reservation, and tend not to have any motivation to visit the establishment during quiet periods. Furthermore, even during busy periods, it is not known in advance the type of menu that will be ordered by the user; accordingly, the unit cost may not increase. Consequently, the sales of eating and drinking establishments cannot be efficiently increased merely by providing information about the eating and drinking establishments on the Internet or the like.

### Means Used to Solve the Problems

Accordingly, the present inventor invented a system for providing plans to eating and drinking establishments in which users who can increase the sales of eating and drinking establishments are urged to visit the establishments by the setting of plans by the eating and drinking establishments corresponding to dates, times, and scenarios such as quiet periods, busy periods, and the like, and providing these plans via a network such as the Internet or the like, in this way allowing an efficient increase in the sales of the eating and drinking establishments.

A first aspect of the present invention is a system for providing plans to eating and drinking establishments that can provide, to a user terminal used by a user, information on plans corresponding to dates, times, and scenarios via a network, characterized in that said system for providing plans to eating and drinking establishments comprises: eating and drinking establishment information storage means for storing attribute information for said eating and drinking establishments and information relating to plans corresponding to dates, times, and scenarios provided by said eating and drinking establishments; reservation information storage means for storing information relating to reservations from users for said plans; plan acceptance means for receiving, from terminals of said eating and drinking establishments, information relating to plans set by said eating and drinking establishments, and storing this information in said eating and drinking establishment information storage means; plan retrieval means for receiving search conditions for said plans from said user terminals, performing a search from said eating and drinking establishment information storage means in order to determine whether or not there are plans that agree with said search conditions, and sending the search results to said user terminals; and reservation acceptance means for receiving, from the user terminal, information relating to reservations for a plan selected by the user, and registering the reservations by storing this information in said reservation information storage means.

According to the configuration of the present invention, an eating and drinking establishment can provide plans corresponding to dates, times, and scenarios such as quiet periods, busy periods, and the like. As a result, users can be attracted during quiet periods, and users with a high unit cost can be motivated to visit the establishment during busy periods. This leads to an expansion of sales. As a result, an efficient increase in the sales of the eating and drinking establishment as a whole can be achieved.

The system for providing plans to eating and drinking establishments in a second aspect of the present invention is a system for providing plans to eating and drinking establishments according to claim 1, characterized in that said system for providing plans to eating and drinking establishments further comprises:

reservation contents confirmation means for receiving, from said user terminals, information relating to the cancellation of reserved plans, determining whether or not cancellation is possible by referring to information relating to said plans stored in said eating and drinking establishment information storage means, transmitting, to said user terminal, the fact that the reservations have been canceled as cancellation handling if cancellation is possible, and transmitting, to said user terminal, an indication that cancellation is not possible if cancellation is not possible.

After reservations have been made at an eating and drinking establishment, there may be cases in which it is desired to cancel the reservations because other important plans intervene or the like. By using the construction of the present invention, cancellation is also possible.

A system for providing plans to eating and drinking establishments according to a third aspect of the present invention further comprises reservation confirmation notification means for acquiring the email address of said user from said reservation information storage means after storing, in said reservation information storage means, information relating to a reservation received from said user terminal by said reservation acceptance means, and transmitting, to said email address, an email confirming the reservation.

It is desirable to transmit a confirmation of reservations to the user after a plan has been reserved as in the present [aspect of the] invention. The reason for this is that in this way, the user can easily re-confirm the content of a plan, and can also prevent reservations from being illegitimately made by a third party.

In a system for providing plans to eating and drinking establishments according to a fourth aspect of the present invention, the reservation confirmation notification means further acquires, after storing, in said reservation information storage means, information relating to reservations received from said user terminal by said reservation acceptance means, from said eating and drinking establishment information storage means the email address of the eating and drinking establishment providing the plan for which said reservations have been made, and transmits an email indicating that reservations have been made to said email address of said eating and drinking establishment.

It is desirable that the eating and drinking establishment providing the plan be notified that reservations have been made after the plan has been reserved as in the present [aspect of the] present invention. The reason for this is that the eating and drinking establishment can thus prevent the acceptance of reservations exceeding the capacity of the establishment as a result of accepting reservations by telephone or the like other than the Internet.

### EFFECT OF THE INVENTION

The present invention can provide plans corresponding to dates, times, and scenarios such as quiet periods, busy periods, and the like to users. Accordingly, users can also be given a motivation to visit eating and drinking establishments during quiet periods for which reservations have been difficult to obtain in the past, and there are prospects for increasing the sales of the eating and drinking establishments. Furthermore, even during busy periods for which reservations are easier to obtain, users will be provided with plans with a high user unit cost, whereby users with a high user unit cost will visit the establishments. By providing such plans for eating and drinking establishments, it is possible to increase the sales of the eating and drinking establishments as a whole.

### BRIEF DESCRIPTION OF THE DRAWINGS

FIG. 1 is a system structure diagram showing one example of the system construction of the present invention;

FIG. 2 is a flow chart showing one example of the processing process of the present invention;

FIG. 3 shows one example of the search screen;

FIG. 4 shows one example of the search results screen;

FIG. 5 shows one example of the details screen;

FIG. 6 shows one example of the free day listing screen;

FIG. 7 shows one example of the reservation information input screen;

FIG. 8 shows one example of the “reservations completed” screen;

FIG. 9 shows one example of the reservation content confirmation screen;

FIG. 10 shows one example of the reservation content listing screen;

FIG. 11 shows one example of the “cancellation completed” screen; and

FIG. 12 shows one example of the cancellation error screen.

### BEST MODE FOR CARRYING OUT THE INVENTION

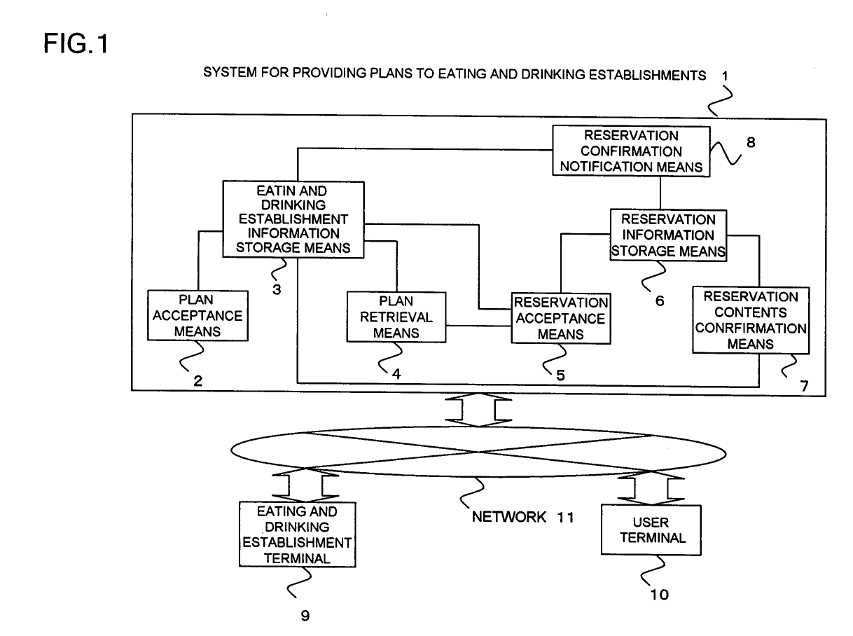

One example of the system construction of a system 1 for providing plans to eating and drinking establishments according to the present invention will be described with reference to the system construction diagram shown in FIG. 1. The system 1 for providing plans to eating and drinking establishments is capable of transmitting and receiving information between a computer terminal (eating and drinking establishment terminal 9) used by the eating and drinking establishment and computer terminals (user terminals 10) used by users of the eating and drinking establishment via a network 11 such as the Internet or the like. Furthermore, the eating and drinking establishment terminal 9 and user terminals 10 may be portable terminals such as cell phones, or a PHS, PDA, or other such device.

The processing of the system 1 for providing plans to eating and drinking establishments of the present invention is performed on a computer terminal (including a server) having a calculation processing device such as a CPU or the like, and a storage device such as RAM, a hard disk, or the like. The programs that run the system 1 for providing plans to eating and drinking establishments are recorded on the hard disk of this computer terminal, and are read into the RAM or the like by performing a specified operation, and processing is performed by executing the functions (means) in the calculation processing device. Furthermore, the information stored in the storage means used in this processing is stored in the RAM, hard disk, or the like in various file saving formats such as databases, data files, or the like, and processing is performed by appropriately reading out this information during processing. The results of processing are also written and appropriately stored in the storage device such as a RAM, hard disk, or the like. The various means in the present invention have functions that are merely separated in logical terms; these functions may occupy the same regions in physical or actual terms.

The system 1 for providing plans to eating and drinking establishments has plan acceptance means 2, eating and drinking establishment information storage means 3, plan retrieval means 4, reservation acceptance means 5, reservation information storage means 6, reservation contents confirmation means 7, and reservation confirmation notification means 8.

The plan acceptance means 2 constitutes means for receiving via a network 11 information relating to plans corresponding to dates, times, and scenarios corresponding to quiet periods, busy periods, and the like which is input into the eating and drinking establishment 9 by a person in charge at the eating and drinking establishment, transmitted from the eating and drinking establishment terminal 9, and provided to users, and storing this information in the eating and drinking establishment information storage means 3. Information relating to plans includes information such as dates and times for which plans are provided, number of persons, course menus, prices, number of plans provided (number of persons per day for which plans can be reserved), and period during which cancellation is possible (period indicating the date up to which the reserved day can be canceled)

The term “quiet periods” refers to days of the week and time periods in which there are few users at the eating and drinking establishment, e.g., weekdays such as Monday and Tuesday, and time periods including 5:00 PM to 7:00 PM, and 9:00 PM or later. However, such periods are not provided by way of limitation, as long as these periods are days of the week or time periods during which there are few users. On the other hand, the term “busy periods” refers to days of the week and time periods during which there are numerous users of the eating and drinking establishment; for example, weekdays such as Thursday and Friday, and time periods including 7:00 PM to 9:00 PM. However, such periods are not provided by way of limitation, as long as these periods are days of the week or time periods during which there are many users. As was described above, the plans provided to users by the eating and drinking establishment are plans corresponding to dates, times, and scenarios such as quiet periods, busy periods, and the like, and may include the provision of plans that are less expensive than usual during quiet periods, the provision of plans that are more expensive than usual during busy periods (these are more expensive because the plans are high-quality plans), and the like, Furthermore, scenarios include events such as Christmas Eve, Valentine's Day, and the like.

The eating and drinking establishment information storage means constitutes means for storing information relating to attributes of the eating and drinking establishment such as the name, address, telephone number, and email address of the eating and drinking establishment, the nearest train station, a map of the surrounding area, menus, average price ranges, and the like, and information relating to plans provided by the eating and drinking establishment.

The plan retrieval means 4 constitutes means for the input of plan search conditions by the users from a user terminal 10, receiving these search conditions, performing a search in order to determine whether or not there is a corresponding plan on the basis of information stored in the eating and drinking establishment information storage means 3, and transmitting the results to the user terminal 10.

The reservation acceptance means 5 constitutes means for accepting reservations for plans of the eating and drinking establishment thought to be usable as a result of the search made by the user. Here, information relating to reservations is received from the user terminal 10, and reservation information is stored in the reservation information storage means 6. Furthermore, an indication that one set of these reservations has been entered (i.e., that the number of plans provided has been reduced by one) is also stored in the eating and drinking establishment information storage means 3. Information relating to reservations may include the reserved date and time, the number of users, the plan used, and attribute information such as the name, address, telephone number, email address, and the like of the reserving party. Furthermore, this information may also include the object of the user, items desired by the user, and the like.

Furthermore, in cases where reservations are accepted, the reservation acceptance means 5 issues a reservation number to the user, and stores this as well in the reservation information storage means 6.

The reservation information storage means 6 constitutes means for storing information relating to reservations received from the user terminal 10 using the reservation acceptance means 5.

The reservation contents confirmation means 7 constitutes means for acquiring information relating to reservations from the reservation information storage means 6 by receiving inquiries regarding the conditions of reservations for reserved plans from the user terminals 10, and transmitting the acquired information relating to these reservations to the user terminals 10. Furthermore, the reservation contents confirmation means 7 constitutes means for receiving information regarding applications to cancel reserved plans, and handling the cancellation of these reservations in cases where cancellation is possible. Specifically, information relating to reservations stored in the reservation information storage means 6 is deleted, and a flag indicating cancellation is set. Furthermore, in cases where cancellation handling is adopted, an indication that there has been one cancellation of the abovementioned plan (the number of [available] plans is increased by one) is stored in the eating and drinking establishment information storage means 3.

In order to cancel reservations, the input of attribute information such as the reservation number, MAIL ADDRESS, and the like is received from the user terminal 10, a search is made in order to determine whether or not there is information relating to reservations that agree with this information, and in cases where there is information that agrees with this information, a judgment is made as to whether or not cancellation is possible. In cases where cancellation is possible, cancellation handling is adopted. On the other hand, in cases where cancellation is not possible (for example, in cases where the cancellation period has expired or the like), an indication that cancellation is not possible is transmitted to the user terminal 10.

The reservation confirmation notification means 8 constitutes means for transmitting, at a specified timing, an email notifying the user of the confirmation of reservations to the email address of the user. This is also done in order to prevent unintended persons claiming the reservation. Furthermore, in cases where reservations are accepted, it is also desirable that the reservation confirmation notification means 8 transmit a notification that the plan has been reserved by email to the email address of the eating and drinking establishment providing the plan. The timing at which these notifications are transmitted may be immediately following the entry of the reservations, after a specified time has elapsed, on a specified day of the week, or the like.

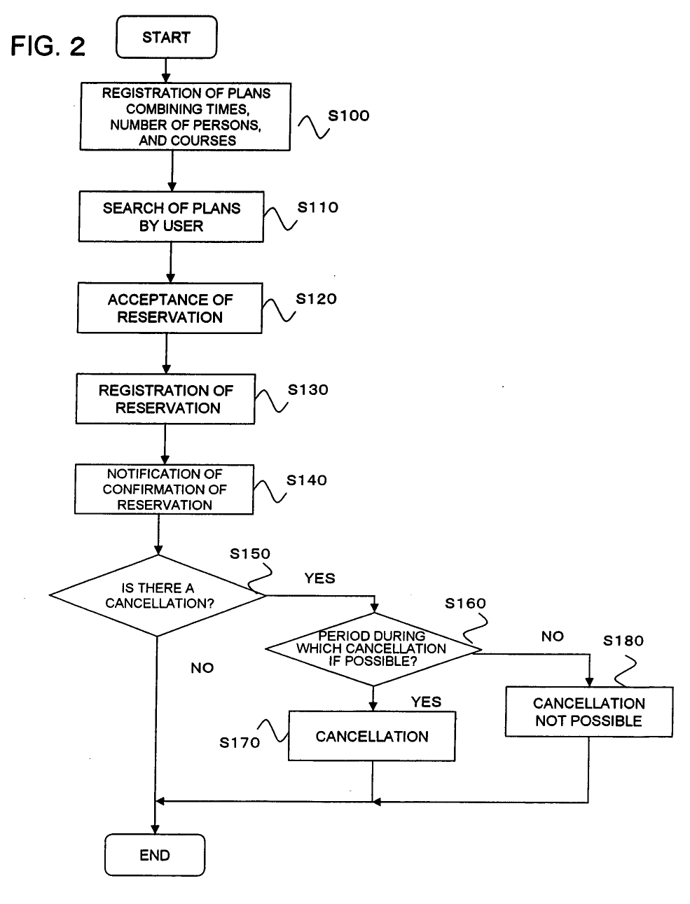

Next, one example of the processing process of the system 1 for providing plans to eating and drinking establishments of the present invention will be described with reference to the flow chart shown in FIG. 2, and the system construction diagram shown in FIG. 1.

First, the person in charge at the eating and drinking establishment determines the dates and times, number of persons, course menus, prices, number of plans provided, periods during which cancellation is possible, and the like, in plans provided to users corresponding to dates, times, and scenarios such as quiet periods, busy periods, and the like. Then, information relating to these plans is input by the eating and drinking establishment terminal 9, and this is transmitted to a specified system 1 for providing plans to eating and drinking establishments. In this case, it is also desirable that the period for which the plans are offered be input. Here, for example, considering cases in which the eating and drinking establishment is attempting to attract users during quiet periods, the plans that are provided may be special plans with inexpensive prices. Furthermore, in cases where the eating and drinking establishment is considering increasing the unit price during busy periods, for example, the plans that are provided may be plans which have higher-than-usual prices due to high quality, or the like (the user unit cost can be doubled by providing an 8,000-yen plan where only a 4,000-yen plan is ordinarily provided).

The plan acceptance means 2 receives information relating to plans from the eating and drinking establishment terminal 9, and registers this information as plans by storing the information in the eating and drinking establishment information storage means 3 (S100)

In this way, the eating and drinking establishment provides information for plans corresponding to dates, times, and scenarios such as quiet periods, busy periods, and the like, and allows a search by users via the network 11.

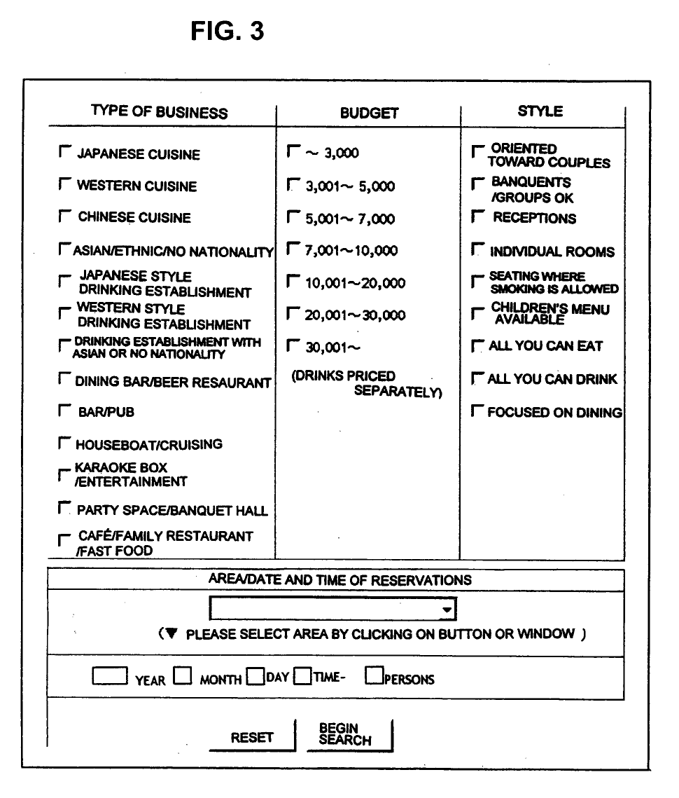

In cases where a user desires to use some plan, the user accesses the system 1 for providing plans to eating and drinking establishments by a specified method from the user terminal 10, and inputs plan search conditions via a search screen such as that shown in FIG. 3.

In the case of FIG. 3, the type of business, budget, style, area of the eating and drinking establishment, date and time, and number of users are input as search conditions, and these search conditions and a search request are transmitted to the system 1 for providing plans to eating and drinking establishments from the user terminal 10 by pressing the “begin search” button.

These search conditions and search request are received by the plan retrieval means 4, so that a search is made on the basis of the eating and drinking establishment information storage means 3 as to whether or not a plan exists that corresponds to these search conditions (S110).

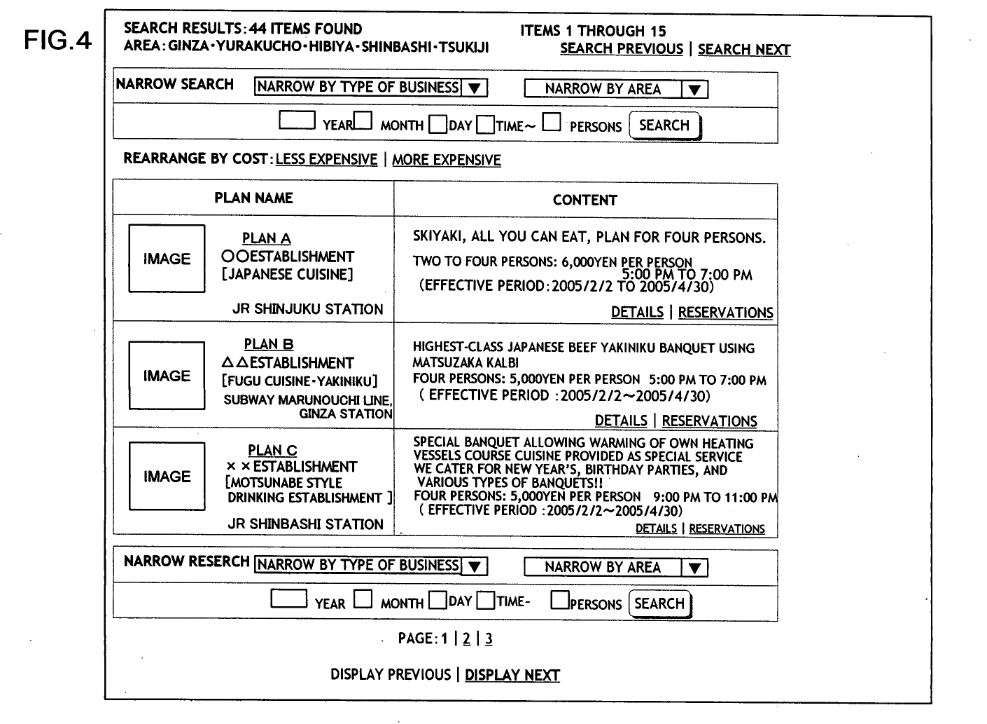

Then, in cases where a corresponding plan exists, the results are transmitted to the user terminal 10 from the plan retrieval means 4 on a search results screen such as that shown in FIG. 4. It is desirable that a link to reservations be provided on this search results screen so that the plan can be immediately reserved.

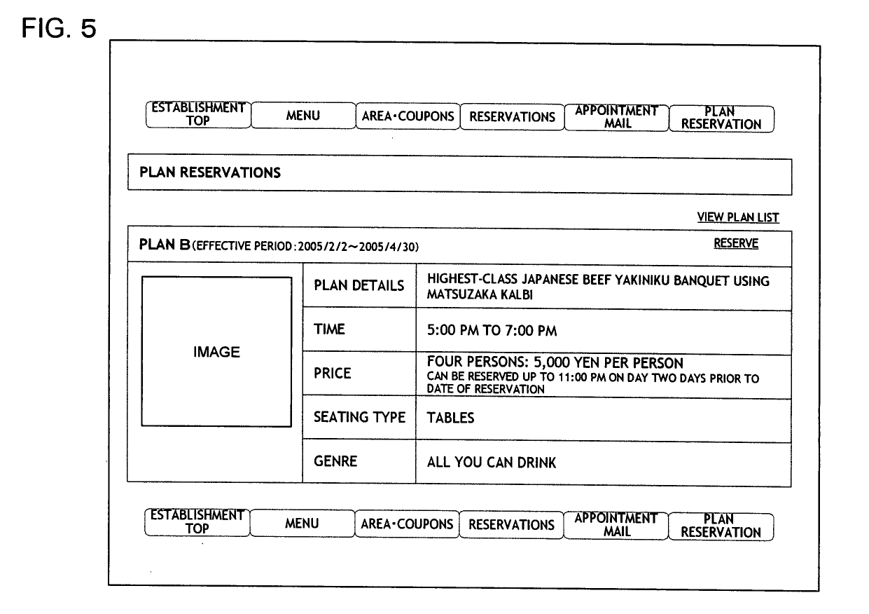

By viewing this search results screen, the user investigates whether or not there is any plan desired by the user, and makes reservations for a certain plan while viewing detailed information if necessary (a link may be provided to allow the detailed information to be viewed) (S120). One example of the details screen showing detailed information for plans is shown in FIG. 5. Furthermore, the transmission of the details screen can be accomplished by the user pressing the abovementioned link, so that detailed information relating to the corresponding plan is acquired by the plan retrieval means 4 from the eating and drinking establishment information storage means 3, and transmitting this information to the user screen 10 on the details screen describing this information.

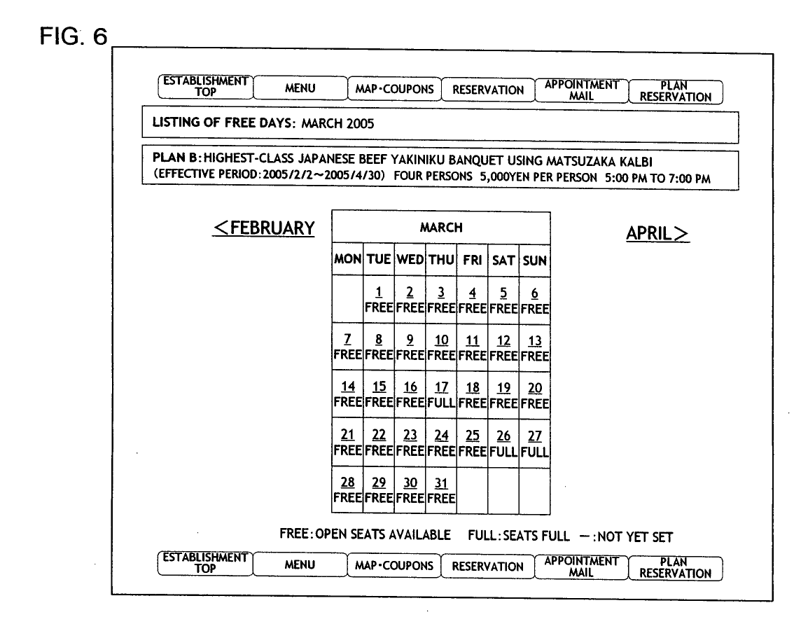

In cases where the plan is reserved from the search results screen, a free day listing screen is transmitted to the user terminal 10 from the reservation acceptance means 5 by pressing the link to reservations. For example, in a case where the user wishes to reserve plan A, the free day listing screen is displayed on the user terminal 10 when the user presses “reservations” provided in the window for the content of plan A. One example of the free day listing screen is shown in FIG. 6.

The free day listing screen is a screen showing information indicating the open availability for each date of the plan selected by the user. Whether or not there is open availability for a plan can be judged by referring to the number of plans stored in the eating and drinking establishment information storage means 3. As was described above, the number of plans provided on a given day is reduced by one in the eating and drinking establishment information storage means 3 each time that reservations are entered. Accordingly, when the number of plans provided reaches zero, the eating and drinking establishment is fully booked; otherwise, it can be judged that empty seats are available.

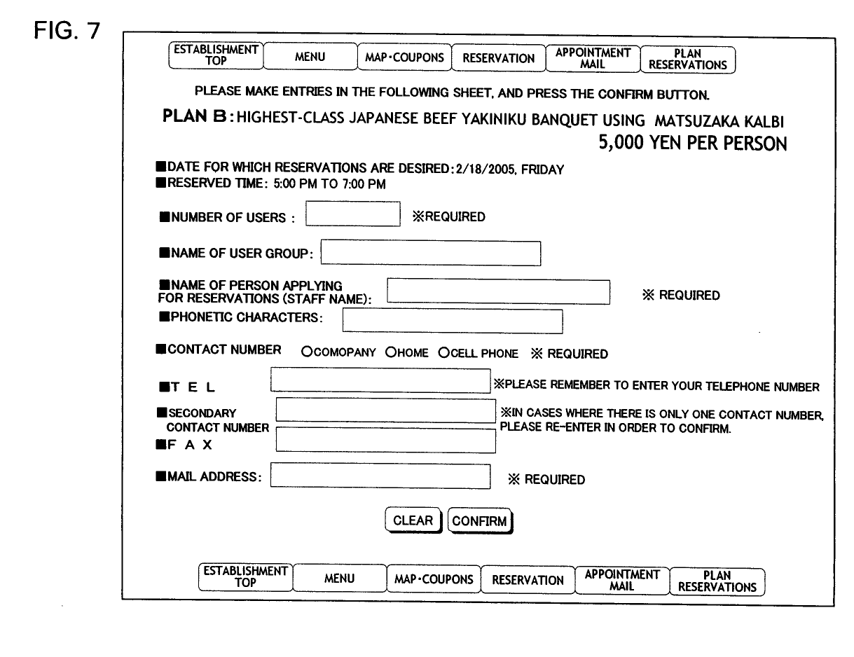

When the user presses a date on which it is indicated by the free day listing screen that empty seats are available, the reservation acceptance means 5 transmits the reservation input screen to the user terminal 10, and information relating to the reservations is input on this screen. One example of the reservation information input screen is shown in FIG. 7.

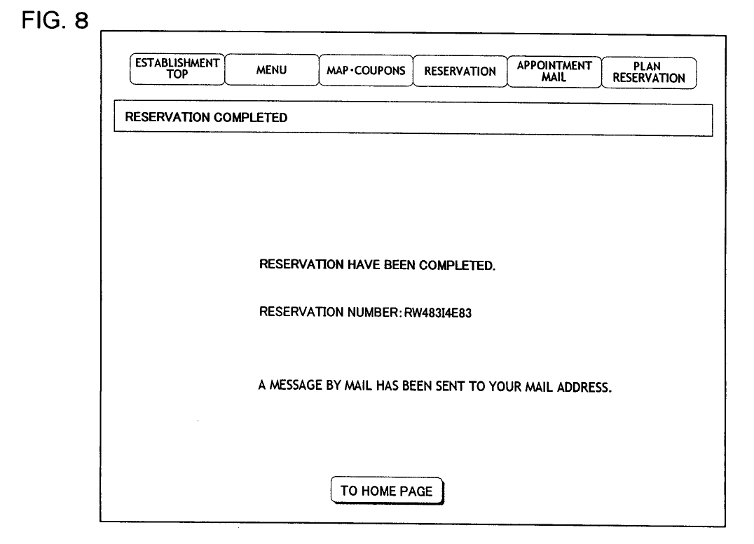

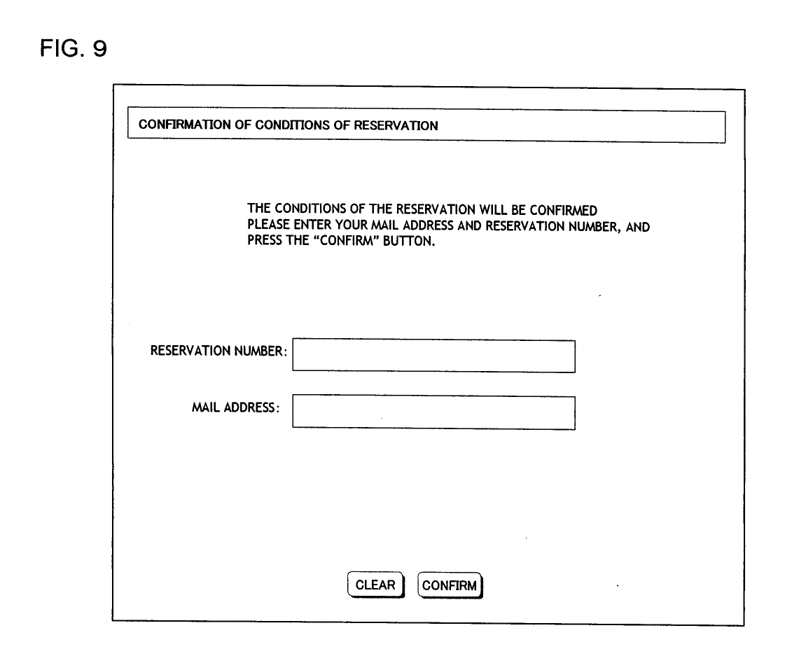

When the “send” button on the reservation information input screen is pressed, the input information relating to the reservations is transmitted to the system 1 for providing plans to eating and drinking establishments from the user terminal 10. The reservation acceptance means 5 of the system 1 for providing plans to eating and drinking establishments receives the information transmitted from the user terminal 10, and stores this information in the reservation information storage means 6, so that the reservation of the plan by the user is registered (S130). Furthermore, in cases where the reservation acceptance means 5 registers reservations, the reservation acceptance means 5 issues a reservation number that identifies the reservations (this number is not limited to numerals alone, but may also include character symbols or the like) to the user, and stores this in the reservation information storage means 6; furthermore, this is transmitted to the user terminal 10. In this case, it is desirable that a “reservations completed” screen such as that shown in FIG. 8 be transmitted to the user terminal 10.

Once the reservation of a plan has been registered, the reservation acceptance means 5 stores an indication that one set of reservations has been entered (i.e., an indication that the number of plans provided has been reduced by one) in the eating and drinking establishment information storage means 3.

Once reservations for a plan corresponding to dates, times, and scenarios such as quiet periods, busy periods, or the like have been received from the user terminal 10 used by the user, the reservation confirmation notification means 8 acquires the email address of the user stored in the reservation information storage means 6, and transmits an email alerting that reservations have been made to this email address (S140). As a result, reservations resulting from mischief of a third party can also be prevented.

At a specified timing, it is desirable that the reservation confirmation notification means 8 acquire the email address of the eating and drinking establishment from the attribute information stored in the eating and drinking establishment information storage means 3, acquire information relating to reservations stored in the reservation information storage means 6, and transmit to this email address an email indicating that new reservations have been entered for the plan provided by the eating and drinking establishment, and describing information relating to the reservations.

There may be cases in which it is desired to cancel a reserved plan for reasons such as inconvenience after the reservations have been made by the user (S150). In such cases, the system 1 for providing plans to eating and drinking establishments is accessed from the user terminal 10 by a specified method, and a cancellation screen used for cancellation is displayed on the user terminal 10 by a specified method.

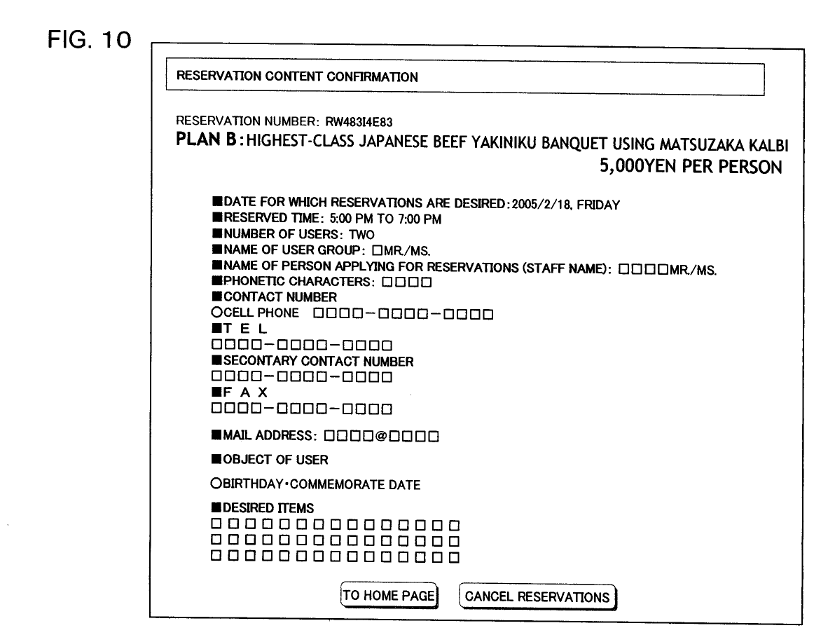

For example, the user displays a reservation content confirmation screen on the user terminal 10 by a specified method, and inputs the reservation number and email address into this screen. The reservation contents confirmation means 7 receiving this performs a search in order to ascertain whether or not information relating to reservations that match this reservation number and email address has been stored in the reservation information storage means 6, and if corresponding information exists, the reservation contents confirmation means 7 acquires information relating to these reservations from the reservation information storage means 6, and transmits a reservation content listing screen such as that shown in FIG. 10 to the user terminal 10.

A button for receiving the cancellation of the reservations is provided on the reservation content listing screen; by pressing this button, the user causes information relating to an application for cancellation to be transmitted to the reservation contents confirmation means 7 from the user terminal 10.

The reservation contents confirmation means 7 receiving this information judges whether or not cancellation of the reservations is possible on the basis of the cancellation acceptance period in the information relating to plans stored in the eating and drinking establishment information storage means 3 (S160), and in cases where cancellation is possible, the reservation contents confirmation means 7 deletes the information relating to reservations stored in the reservation information storage means 6, and sets a flag indicating cancellation, so that cancellation handling is adopted for the reservations (S170). Furthermore, in cases where cancellation handling is adopted, an indication that one cancellation has been entered for the corresponding plan (an indication that the number of plans provided has been increased by one) is stored in the eating and drinking establishment information storage means 3.

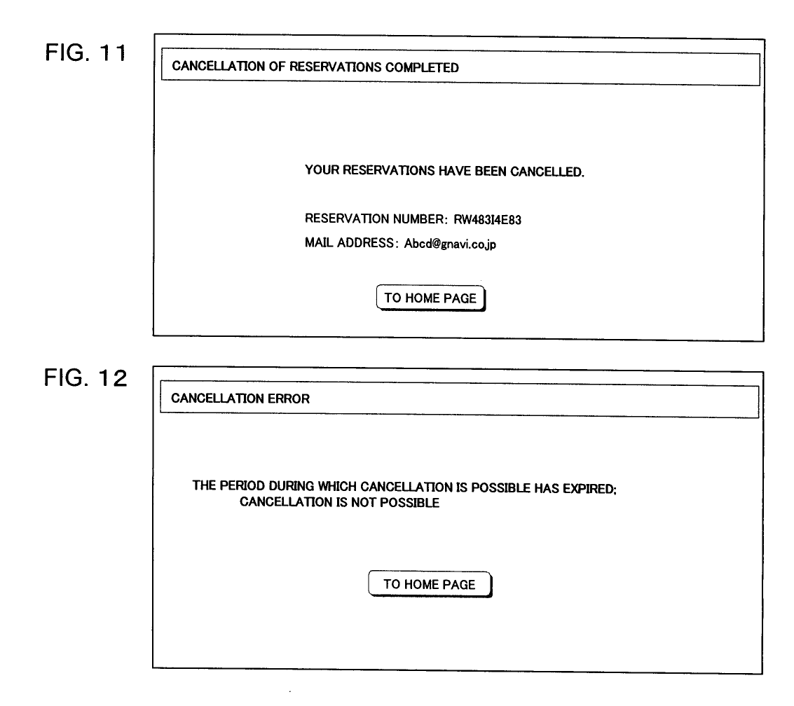

When cancellation handling has been completed, a “cancellation completed” screen such as that shown in FIG. 11 is transmitted to the user terminal 10 by the reservation contents confirmation means 7.

On the other hand, in cases where the period is not the period during which cancellation is possible, cancellation cannot be performed; accordingly, a cancellation error screen such as that shown in FIG. 12 is transmitted to the user terminal 10 by the reservation contents confirmation means 7 (S180).

### INDUSTRIAL APPLICABILITY

The present invention as described above can provide plans corresponding to dates, times, and scenarios such as quiet periods, busy periods, and the like to users; accordingly, users can be motivated to visit the establishment in question even during quiet periods for which reservations have conventionally been difficult to obtain, and there are prospects for an increase in the sales of this eating and drinking establishment. Furthermore, plans with a high user unit cost are provided during busy periods as well, for which reservations have been easy to obtain, whereby users with a high user unit cost will visit the establishment. The provision of such eating and drinking establishment plans may lead to an increase in the sales of the eating and drinking establishment as a whole.

1. A system for providing plans to eating and drinking establishments that provide, to a user terminal used by a user, information on plans corresponding to dates, times, and scenarios via a network, said system for providing plans to eating and drinking establishments comprising:
eating and drinking establishment information storage means for storing attribute information for said eating and drinking establishments and information relating to plans corresponding to dates, times, and scenarios provided by said eating and drinking establishments;
reservation information storage means for storing information relating to reservations from users for said plans;
plan acceptance means for receiving, from terminals of said eating and drinking establishments, information relating to plans set by said eating and drinking establishments, and storing this information in said eating and drinking establishment information storage means;
plan retrieval means for receiving search conditions for said plans from said user terminals, performing a search from said eating and drinking establishment information storage means in order to determine whether or not there are plans that agree with said search conditions, and sending the search results to said user terminals; and
reservation acceptance means for receiving, from the user terminal, information relating to reservations for a plan selected by the user, and registering the reservations by storing this information in said reservation information storage means.

2. The system for providing plans to eating and drinking establishments according to claim 1, wherein said system for providing plans to eating and drinking establishments further comprises:
reservation contents confirmation means for receiving, from said user terminals, information relating to the cancellation of reserved plans, determining whether or not cancellation is possible by referring to information relating to said plans stored in said eating and drinking establishment information storage means, transmitting, to said user terminal, the fact that the reservations have been canceled as cancellation handling if cancellation is possible, and transmitting, to said user terminal, an indication that cancellation is not possible if cancellation is not possible.

3. The system for providing plans to eating and drinking establishments according to claim 1, wherein said system for providing plans to eating and drinking establishments further comprises reservation confirmation notification means for acquiring the email address of said user from said reservation information storage means after storing, in said reservation information storage means, information relating to a reservation received from said user terminal by said reservation acceptance means, and transmitting, to said email address, an email confirming the reservation.

4. The system for providing plans to eating and drinking establishments according to claim 3, wherein said reservation confirmation notification means further acquires, after storing, in said reservation information storage means, information relating to reservations received from said user terminal by said reservation acceptance means, from said eating and drinking establishment information storage means the email address of the eating and drinking establishment providing the plan for which said reservations have been made, and transmits an email indicating that reservations have been made to said email address of said eating and drinking establishment.

5. The system for providing plans to eating and drinking establishments according to claim 2, wherein said system for providing plans to eating and drinking establishments further comprises reservation confirmation notification means for acquiring the email address of said user from said reservation information storage means after storing, in said reservation information storage means, information relating to a reservation received from said user terminal by said reservation acceptance means, and transmitting, to said email address, an email confirming the reservation.

6. The system for providing plans to eating and drinking establishments according to claim 5, wherein said reservation confirmation notification means further acquires, after storing, in said reservation information storage means, information relating to reservations received from said user terminal by said reservation acceptance means, from said eating and drinking establishment information storage means the email address of the eating and drinking establishment providing the plan for which said reservations have been made, and transmits an email indicating that reservations have been made to said email address of said eating and drinking establishment.
